(19) United States
(12) Patent Application Publication
(10) Pub. No.: US 2006/0014077 A1
(43) Pub. Date: Jan. 19, 2006

(54) Process of preparing coating for positive electrode materials for lithium secondary batteries and positive electrodes for lithium secondary batteries

(75) Inventors: Michiru Hatou, Osaka (JP); Mitsuhiro Takeno, Osaka (JP); Takao Kuromiya, Osaka (JP)

Correspondence Address: RATNERPRESTIA, P.O. BOX 980, VALLEY FORGE, PA, 19482, US

(73) Assignee: Matsushita Electric Industrial Co., Ltd.

(21) Appl. No.: 11/182,411

(22) Filed: Jul. 15, 2005

(30) Foreign Application Priority Data
Jul. 15, 2004 (JP) 2004-208772

(51) Int. Cl. H01M 4/48; B05D 5/12

(52) U.S. Cl. 429/231.1; 427/126.3

(57) ABSTRACT

A process of producing a positive electrode for lithium secondary batteries, including: at least, a coating preparing step of preparing a coating for a positive electrode material that includes an active material, which is a Li-containing mixed oxide, a conductive additive, a binder and a solvent; a coating step of coating the coating for a positive electrode material onto a current collector; a drying step of removing the solvent from the coating coated on the current collector; and a rolling step, wherein in the above described coating preparing step and coating step, the ratio of the total volume of the active material and the conductive additive to the volume of the solvent in the coating is kept in the range expressed by the following equation:
0.05≦(volume of active material 1c+volume of conductive additive 1d)/volume of solvent≦1.00.

### BACKGROUND OF THE INVENTION

1. Field of the Invention

The present invention relates to a process of preparing a coating for a positive electrode material for lithium secondary batteries and a positive electrode for lithium secondary batteries produced by the process.

2. Related Art of the Invention

With the rapid progress of miniaturization and weight reduction of electronic devices in recent years, there have been increasing demands in the field of batteries, as power sauces for such electronic devices, towards miniaturization, weight reduction and high capacity, and lithium secondary batteries of higher energy density have been actively researched and developed and put to practical use. To realize further miniaturization and weight reduction of electronic devices, lithium secondary batteries having a much higher performance are being awaited.

A positive electrode for lithium secondary batteries is produced by a process including: at least, a coating preparing step of preparing a coating for a positive electrode material that includes an active material, which is a Li-containing mixed oxide, a conductive additive, a binder and a solvent; a coating step of coating the coating on a current collector made up of aluminum foil or the like; a drying step of removing the solvent from the coating coated on the current collector; and a rolling step. The reason for using a conductive additive in the production of the above described positive electrode is that the electronic conductivity of the active material for the positive electrode, which is a Li-containing transition metal oxide, is lower than that of commonly used conductive materials. Addition of a conductive additive having a high electronic conductivity provides a high electronic conductivity between the current collector and the active material for the positive electrode or among the active material for the positive electrode.

However, a conductive additive, whose particle size is small compared with that of the active material, is very hard to disperse in a solvent, and therefore being difficult to uniformly mix with the active material for the positive electrode. Thus, use of a conductive additive poses a problem of decreasing the electronic conductivity of the positive electrode and increasing the internal resistance of batteries, causing deterioration of battery performance such as battery capacity and cycle performance.

Thus, there is proposed a process for producing a positive electrode for lithium secondary batteries in which in order to increase electronic conductivity of the positive electrode, a conductive additive that contains 0.5 to 10% by mass of a volatile component is used and the functional groups contained in the volatile component are allowed to produce adsorption action between the conductive additive and the binder used so that agitation shearing force acts on the conductive additive at the time of coating preparation (refer to, for example, Japanese Patent Laid-Open No. 2003-249224).

As described above, in conventional processes, to disperse a conductive additive, agitation shearing force is applied to the conductive additive. To allow sufficient agitation shearing force to act on a conductive additive, a process has been commonly used in which a coating is prepared by first kneading the ingredients of the coating with a high conductive-additive concentration and then diluting the kneaded ingredients.

The term “the ingredients of the coating with a high conductive-additive concentration” herein used means that in the ingredients, the ratio of the volume of the active material and conductive additive to the volume of the solvent, that is, {(volume of active material+volume of conductive additive)/volume of solvent} is about 1.49 or 2.2.

And as a conductive additive, carbon black such as Ketjenblack or acetylene black, fiber carbon or flake graphite has been used.

### SUMMARY OF THE INVENTION

In coatings for positive electrode materials prepared by the above described conventional processes of producing lithium secondary batteries, the dispersibility of the conductive additive used is high immediately after the preparation of the compound, and the electronic conductivity of the positive electrode produced using the coating compound for a positive electrode material right after the preparation is very high. However, once the coating is subjected to shearing force at the time of coating, re-agitation or the like, the aggregation of the conductive additive rather progresses, and the distribution of the conductive additive in the positive electrode material layer becomes non-uniform, bringing the positive electrode in such a state that is shown in FIG. 6 in terms of its cross section.

FIG. 6 shows a cross section of a positive plate 1a for conventional lithium secondary batteries in which the aggregation of the conductive additive progresses and the distribution of the same in the positive electrode material layer is in the non-uniform state. The positive plate 1a is made up of a current collector 1b and positive electrode material layers formed on both sides of the current collector 1b. The positive electrode material layers each contain an active material 1c, which is a Li-containing mixed oxide, a binder 1e and a conductive additive 1d.

Further, the shearing force applied to a coating for a positive electrode material is not uniform in the actual coating step or re-agitation step, whereby variations are created in the degree of the progress of aggregation, that is, in the electronic conductivity of the produced positive electrodes. This poses a problem of increasing the variation in battery performance such as battery capacity and cycle performance among the batteries as final products.

The present invention aims at solving the above described problems with conventional processes. Accordingly, the object of the present invention is to provide a process of preparing a coating for a positive electrode material for lithium secondary batteries which can maintain high battery performance and a positive electrode for lithium secondary batteries produced by the process.

To solve the above described problems, the 1^{st} aspect of the present invention is a process of preparing a coating for a positive electrode material for lithium secondary batteries, the coating comprising, at least, an active material which is a Li-containing mixed oxide, a conductive additive, a binder and a solvent,
wherein the process comprises mixing the active material, conductive additive, binder and solvent so that the ratio of the volume of the active material and the volume of the conductive additive to the volume of the solvent in said coating is kept during the processing in the range expressed by the following equation:
   0.05≦(volume of active material+volume of conductive additive)/volume of solvent≦1.00.

The 2^{nd} aspect of the present invention is the process of preparing a coating for a positive electrode material for lithium secondary batteries according to the 1^{st} aspect of the present invention, wherein the conductive additive accounts for 1.5% or more and 10% or less of the volume of the entire coating for a positive electrode material.

The 3^{rd} aspect of the present invention is the process of preparing a coating for a positive electrode material for lithium secondary batteries according to the 1^{st} aspect of the present invention, wherein the conductive additive accounts for 1.5% or more and 2% or less of the volume of the entire coating for a positive electrode material.

The 4^{th} aspect of the present invention is a positive electrode for lithium secondary batteries produced in: a coating step of applying, onto a current collector, a coating prepared by a process of preparing a coating for a positive electrode material for lithium secondary batteries according to any one of the 1^{st} to the 3^{rd} aspects of the present invention; and a drying step of removing the solvent from the coating applied onto the current collector,
wherein the positive electrode comprises a material layer in which the ratio of the volume of the conductive additive to the total volume of the active material, conductive additive and binder is in the range expressed by the following equation:
   0.03≦(volume of conductive additive)/(volume of active material+conductive additive+binder)≦0.25, and a current collector.

The 5^{th} aspect of the present invention is a positive electrode for lithium secondary batteries produced in: a coating step of applying, onto a current collector, a coating prepared by a process of preparing a coating for a positive electrode material for lithium secondary batteries according to any one of the 1^{st} to the 3^{rd} aspects of the present invention; and a drying step of removing the solvent from the coating applied onto the current collector,
wherein the positive electrode comprises a material layer in which the ratio of the volume of the conductive additive to the total volume of the active material, conductive additive and binder is in the range expressed by the following equation:
   0.03≦(volume of conductive additive)/(volume of active material+conductive additive+binder)≦0.06, and the current collector.

The present invention aims at producing a positive plate for lithium secondary batteries which can maintain high performance by preparing a coating for a positive electrode material in such a manner as to satisfy the above described requirements, thereby not to apply too large amount of agitation shearing force to the conductive additive, unlike conventional processes of producing lithium secondary batteries where too large amount of agitation shearing force to the conductive additive is applied to the conductive.

According to the present invention, provided are a process of preparing a coating for a positive electrode material for lithium secondary batteries which can maintain high battery performance and a positive electrode for lithium secondary batteries produced by the process.

### BRIEF DESCRIPTION OF THE DRAWINGS

FIG. 1 is a cross section of a positive plate for lithium secondary batteries in accordance with the first embodiment of the present invention;

FIG. 2 is a cross section of lithium secondary batteries produced in examples of the present invention;

FIG. 3 is a graph showing the relationship between the volume ratio before diluting of “active material+conductive additive” to “solvent” in a coating for a positive electrode material and the battery capacity of the produced batteries;

FIG. 4 is a graph showing the relationship between the volume ratio before diluting of “active material+conductive additives” to “solvent” in a coating for a positive electrode material and the battery capacity of the produced batteries;

FIG. 5 is a graph showing the relationship between the volume ratio of conductive additives in a coating for a positive electrode material and the battery capacity of the produced batteries;

FIG. 6 is a cross section of a positive plate for conventional lithium secondary batteries; and

FIG. 7 is a graph showing the relationship between the volume ratios of “active material+conductive additive” to “solvent” in a coating for a positive electrode material before and after dilution and the battery capacity of the batteries produced in examples of the present invention.

### DESCRIPTION OF SYMBOLS

1a Positive plate
1b Current collector
1c Active material, which is a Li-containing mixed oxide
1d Conductive additive
1e Binder

### PREFERRED EMBODIMENTS OF THE INVENTION

In the following the preferred embodiments of the present invention will be described in detail.

### Embodiment 1

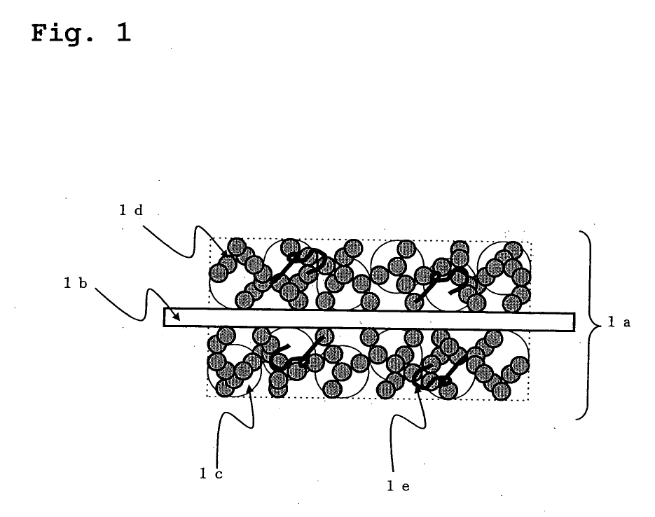

FIG. 1 is a cross section of a positive plate for lithium secondary batteries which is prepared by the process of preparing a coating for a positive electrode material for lithium secondary batteries in accordance with the first embodiment of the present invention.

In FIG. 1, a positive plate 1a is of such construction that an active material 1c, which is a Li-containing mixed oxide, and a conductive additive 1d are bound with a binder 1e on a current collector 1b.

Examples of materials used for the current collector 1b include, but not limited to, foils made of aluminum, aluminum alloy or titanium, just like the case of conventional current collectors.

Examples of materials used for the active material 1c include, but not limited to, lithium-containing mixed metal oxides such as lithium nickel oxide, lithium cobalt oxide or lithium manganese oxide (typically these are represented by LiNiO₂, LiCoO₂ or LiMn₂O₄; however, in most cases, the Li/Ni ratio, Li/Co ratio or Li/Mn ratio deviates from the stoichiometric composition). Either one of these materials alone or two or more together in the form of a mixture or solid solution can be used, but the form in which these materials are used are not limited to any specific one.

Examples of materials used for the conductive additive 1d include, not limited to, carbon black such as Ketjenblack or acetylene black, fiber carbon and flake graphite.

Examples of materials used for the binder 1e include, thermoplastic resin, polymer having rubber elasticity and polysaccarides. Either one of these materials or two or more together in the form of a mixture can be used. Concrete examples are, not limited to, polytetrafluoroethylene, polyvinylidene fluoride, hexafluoropropene copolymers, polyethylene, polypropylene, ethylene-propylene-diene copolymers, styrene-butadiene rubber, polybutadiene, fluorine rubber, polyethylene oxide, polyvinylpyrrolidone, polyester resin, acrylic resin, phenolic resin, epoxy, polyvinyl alcohol, and cellulose resins such as hydroxypropyl cellulose and carboxymethyl cellulose.

Lithium secondary batteries used include: those made up of the positive plate 1a; a negative plate; and a separator provided therebetween which are bent into a circular cylinder or elliptical cylinder or in which the above plates and the separator are superimposed into a laminate.

Examples of negative plates used include: not limited to, those made up of a current collector of for example copper foil and a material layer formed on the collector, wherein the material layer is made of mixture of active material of Li-containing mixed oxide of, for example, graphite and a binder.

Examples of separators used include: not limited to, those made of microporous polyethylene film or microporous polypropylene film with thickness of 10 to 50 μm and porosity of 30 to 70%.

The process of producing the positive plate in accordance with the first embodiment of the present invention will be described.

First, a coating for a positive electrode material is prepared which includes: at least, an active material 1c, which is a Li-containing mixed oxide; a conductive additive 1d; a binder 1e; and a solvent (coating preparing step). Examples of solvents applicable include: not limited to, N-methyl-2-pyrrolidone (NMP); water; 2-butanone; ethanol; cyclohexanone; and dimethylformaldehyde. The ratio of the conductive additive 1d to the coating for a positive electrode material is preferably 1.5 to 10% on the volume basis.

In the preparation of the above described coating for a positive electrode material (in the coating preparing step), dispersers such as, not limited to, planetary mixer, bead mill and triple roll mill can be used.

Examples of processes and devices of coating the coating for a positive electrode material on both sides of the current collector 1b (coating step) include: not limited to, slot die coating (coater); blade coating (coater); forward roll coating (coater); reverse roll coating (coater); gravure coating (coater); and spray coating (coater).

What is important in the above described coating preparing step is that the ratio of (the volume of the active material+the volume of the conductive additive)/the volume of the solvent is kept 0.05 or more and 1.00 or less.

Examples of drying methods of removing the solvent from the coating film formed on the surface of the current collector 1b include, not limited to, heated air and far infrared rays.

When employing the above described production process, positive material layers with a high electronic conductivity as well as a constant coating film resistance as low as 40 to 100 Ω·cm can be obtained, because even if the coating for a positive electrode material is put in shear due to executed coating process and re-stirring or the like, aggregation of the conductive additive does not progress, whereby uniform distribution of the conductive additive is maintained as shown in FIG. 1. The coating film resistance of the positive electrode material layer means the volume resistivity of the present invention.

Use of the positive electrode material layer thus formed makes it possible to realize lithium secondary batteries that excel in battery performance such as battery capacity and high rate performance and create smaller variations.

### EXAMPLES

In the following several examples will be described in which positive plates for lithium secondary batteries were produced employing the process of preparing a coating for a positive electrode material for lithium secondary batteries in accordance with the first embodiment of the present invention and the electronic conductivity of the resultant positive plates was evaluated. Several examples will also be described in which layer-built lithium secondary batteries were produced using the positive plates and the battery capacity of the resultant batteries was evaluated.

Several comparative examples will also be described in which similar evaluation is made using coating for a positive electrode material prepared by conventional processes.

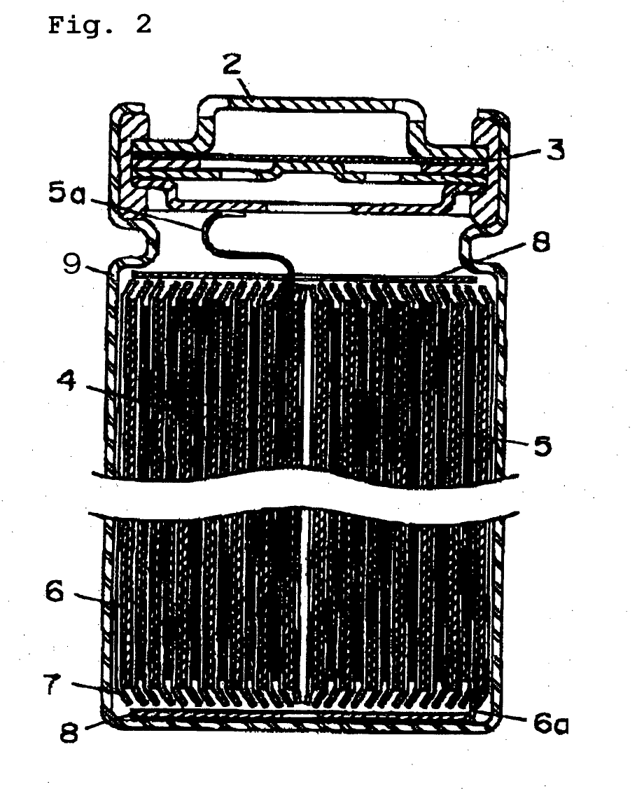

FIG. 2 is a cross section of lithium secondary batteries produced in examples and comparative examples described below.

In each example or comparative example, the coating ingredients used for positive electrode material were: LiCoO₂ with an average diameter, in terms of volume distribution, of 7 to 8 μm as an active material, which is a Li-containing mixed oxide; polyvinylidene fluoride as a binder; and N-methyl-2-pyrrolidone as a solvent. Conductive additives used varied depending on the examples and comparative examples.

In the following the process of producing a positive plate in each example or comparative example will be described.

### Example 1

First, 27 parts by volume of active material, which was Li-containing mixed oxide, 5 parts by volume of acetylene black with a weight average primary particle size of 50 nm, as a conductive additive, and 2 parts by volume of binder were introduced into 66 parts by volume of solvent, and then kneaded for 60 minutes with a planetary mixer to prepare a coating for positive electrode material. In this case, the volume ratio, “(volume of active material+volume of conductive additive)/volume of solvent”, in the coating for the positive electrode material was 0.48.

Another coating for positive electrode material was also prepared by rolling the above described coating for positive electrode material on a roll mill for a day.

These two kinds of coating were applied onto both sides of an aluminum foil core material with a blade maintaining a gap of 300 μm, and the solvent of the coating was removed with heated air at 100° C. to produce positive electrodes (having not undergone rolling).

Then, 5% by weight of polyvinylidene fluoride resin as a binder was mixed into 95% by weight of graphite powder as an active material, and the mixture was dispersed in dehydrated N-methylpyrrolidinone in such a manner as to dissolve polyvinylidene fluoride resin therein to prepare slurry. The slurry was applied onto a negative electrode current collector made of copper foil, dried and rolled. After the current collector was cut to a prescribed size, a negative lead 6a shown in FIG. 2 was welded to the negative electrode current collector to produce a negative plate 6.

Then, the produced positive plate 5 and the produced negative plate 6 were rolled up, with a separator 7 put therebetween, into a swirl, and a positive lead 5a was connected to a sealing plate 2 while a negative lead 6a to the bottom portion of a nickel-plated iron battery case 9, as shown in FIG. 2. Further, insulating rings 8 were arranged on the top and bottom portions of a group of electrode plates 4, respectively, and an organic electrolyte, which was prepared by dissolving LiPF₆ in a mixed solvent of ethylene carbonate and ethyl methyl carbonate at the volume ratio of 1:1 in an amount of 1.5 mol/liter, was poured into the case.

Lastly, the sealing plate 2 and the battery case 9 are integrated by caulking them via an insulating packing 3 to produce a cylindrical battery 18 mm in outer diameter and 65 mm in length.

### Example 2

A positive plate was produced using the same materials and process as those in Example 1, provided that the coating for a positive electrode material was composed of: 68 parts by volume of solvent; 28 parts by volume of active material, which was a Li-containing mixed oxide; 2 parts by volume of acetylene black with a weight average primary particle size of 50 nm, as a conductive additive; and 2 parts by volume of binder. In this case, the volume ratio, “(volume of active material+volume of conductive additive)/volume of solvent”, in the coating was 0.44.

### Comparative Example 1

A positive plate was produced in the same manner as in Example 1, except that the materials use and the coating for a positive electrode material were changed.

First, 30 parts by volume of active material, which was Li-containing mixed oxide and 2 parts by volume of acetylene black with a weight average primary particle size of 50 nm, as a conductive additive, were introduced into 22 parts by volume of solvent, and then kneaded for 30 minutes with a planetary mixer. In this case, the volume ratio, “(volume of active material+volume of conductive additive)/volume of solvent”, in the coating was 1.49.

After that, 2 parts by volume of binder and 42 parts by volume of solvent were added and kneaded for another 60 minutes to prepare a coating for a positive electrode material. The volume ratio, “(volume of active material+volume of conductive additive)/volume of solvent”, in the coating was 0.5.

Another coating for positive electrode material was prepared by rolling the above described coating for positive electrode material on a roll mill for a day.

### Example 3

A positive plate was produced using the same materials and process as those in Example 1, provided that the coating for a positive electrode material was composed of: 65.3 parts by volume of solvent; 31.3 parts by volume of active material, which was a Li-containing mixed oxide; 1.4 parts by volume of acetylene black with a weight average primary particle size of 50 nm, as a conductive additive; and 2 parts by volume of binder. In this case, the volume ratio, “(volume of active material+volume of conductive additive)/volume of solvent”, in the coating was 0.5 while the percentage by volume of the conductive additive to the coating for the positive electrode material was 1.4%.

### Example 4

A positive plate was produced using the same materials and process as those in Example 1, provided that as a conductive additive, used was not acetylene black, but the same weight of graphite as acetylene black used in Example 1.

### Example 5

A positive plate was produced using the same materials and process as those in Example 2, provided that as a conductive additive, used was not acetylene black, but the same weight of graphite as acetylene black used in Example 2.

### Comparative Example 2

A positive plate was produced using the same materials and process as those in Comparative Example 1, provided that as a conductive additive, used was not acetylene black, but the same weight of graphite as acetylene black used in Comparative Example 1.

### Example 6

A positive plate was produced using the same materials and process as those in Example 3, provided that as a conductive additive, used was not acetylene black, but the same weight of graphite as acetylene black used in Example 3.

### Example 7

A positive plate was produced using the same materials and process as those in Example 1, provided that as a conductive additive, used was not acetylene black, but the same weight of mixture of acetylene black and graphite at the ratio of 1:1 as acetylene black used in Example 1.

The evaluations of the positive plates produced in examples 1 to 7 and comparative examples 1, 2 as well as the lithium secondary batteries produced using the above positive plates are shown in Table 1.

In the evaluations, the performance of each lithium secondary battery was confirmed by the battery capacity and high rate performance. The battery capacity was the discharge capacity obtained by charging each battery at a constant current of 400 mA to 4.2 V and then discharging the same at a constant current of 400 mA to 3.0 V. The high rate performance were the ratio of the discharge capacity obtained by charging each of the above battery at a constant current of 400 mA to 4.2 V and then discharging the same at a constant current of 400 mA to 3.0 V, to the battery capacity obtained above.

TABLE 1

| | | | | | | Evaluation of battery performance | | | |
|---|---|---|---|---|---|---|---|---|---|
| | | | | | | | | high rate | |
| | | | | Evaluation of | | | | performance | |
| | Construction | | | electrode plates | | | | (= discharge | |
| | | volume of conductive | | coating film | | battery | | capacity at 20 C./ | |
| | | additive/(total | | resistance | | capacity | | discharge capacity | |
| | | volume of active | | [Ω · cm] | | [mAh] | | at 0.2 C.) | |
| | (total volume of | material + | | right | after | right | after | right | after |
| | active material + | conductive additive + | type of | after | application | after | application | after | application |
| | conductive additive)/ | binder + solvent) | conductive | prepa- | of shearing | prepa- | of shearing | prepa- | of shearing |
| | volume of solvent | [%] | additive | ration | force | ration | force | ration | force |
| Example 1 | 0.48 | 5.00 | Acetylene | 73 | 97 | 1772 | 1717 | 0.84 | 0.71 |
| | | | black | | | | | | |
| Example 2 | 0.46 | 2.00 | Acetylene | 65 | 71 | 1801 | 1770 | 0.91 | 0.82 |
| | | | black | | | | | | |
| Comparative | 1.49 | 2.00 | Acetylene | 86 | 10130 | 1730 | 1438 | 0.73 | 0.42 |
| Example 1 | | | black | | | | | | |
| Example 3 | 0.50 | 1.40 | Acetylene | 101 | 129 | 1708 | 1695 | 0.68 | 0.68 |
| | | | black | | | | | | |
| Example 4 | 0.48 | 5.00 | Graphite | 78 | 98 | 1751 | 1712 | 0.72 | 0.70 |
| Example 5 | 0.46 | 2.00 | Graphite | 70 | 75 | 1762 | 1716 | 0.77 | 0.73 |
| Comparative | 1.49 | 2.00 | Graphite | 93 | 15479 | 1718 | 1180 | 0.71 | 0.35 |
| Example 2 | | | | | | | | | |
| Example 6 | 0.50 | 1.40 | Graphite | 118 | 140 | 1698 | 1692 | 0.68 | 0.67 |
| Example 7 | 0.48 | 5.00 | Acetylene | 76 | 97 | 1760 | 1714 | 0.74 | 0.70 |
| | | | black + | | | | | | |
| | | | graphite | | | | | | |
| | | | (=1:1) | | | | | | |

Results shown in Table 1 revealed as follows.

The results obtained when the volume ratios, “(volume of active material+volume of conductive additive)/volume of solvent”, in the coating for the positive electrode material were 0.48 (Example 1) and 0.44 (Example 2) in the coating preparation step and the coating step reveal that the distribution of the active material and the conductive additive was uniform, and therefore, the coating film resistance of the positive plate was kept as low as 100 Ω·cm or less even when the coating for a positive electrode material right after preparation was subjected to shearing force, and batteries were accomplished which excelled in battery capacity and cycle performance, and besides, created only small variations. In Table 1, though the battery performance was described in terms of battery capacity and high rate performance, excellent high rate performance means excellent cycle performance.

In contrast, the results obtained when the volume ratio, “(volume of active material+volume of conductive additive)/volume of solvent”, in the coating for the positive electrode material were 1.49 (Comparative Example 1) right after introducing 30 parts by volume of active material, which was a Li-containing mixed oxide, and 2 parts by volume of conductive additive into 22 parts by volume of solvent reveal that the distribution of the conductive additive was unstable, and therefore, though the resistance of the coating film of the positive plate which was formed using the coating right after preparation was low, when the coating was subjected to shearing force, the aggregation of the conductive additive progressed, whereby the coating film resistance was rapidly increased, and the battery capacity and the high rate performance of the battery deteriorated.

The positive plates of examples 1 to 3 were almost the same in the volume ratios, “(volume of active material+volume of conductive additive)/volume of solvent”, in the coating for the positive electrode material, but different in the percentage by volume of the conductive additive to the coating for a positive electrode material. The volume ratios of the conductive additive to the coating for a positive electrode material were 5%, 2% and 1.4% in the positive plates of examples 1 to 3, respectively. Table 1 shows that in the batteries of examples 1 and 2, their battery performance was kept high even after they were subjected to shearing force, whereas in the battery of Example 3, its battery performance deteriorated, compared with that of examples 1 and 2, after it was subjected to shearing force. This confirmed that the percentage by volume of the conductive additive to the coating for a positive electrode material affects the battery performance after application of shearing force.

The positive plates of Examples 1, 2, Comparative Example 1 and Example 3 were different from those of Examples 4, 5, Comparative Example 2 and Example 6 in that in the former ones, acetylene black was used as the conductive additive, whereas in the latter ones, graphite was used. It is seen from Table 1 that Examples 4, 5, Comparative Example 2 and Example 6 have similar results and tendencies to those of examples 1, 2, Comparative Example 1 and Example 3. Specifically, in the batteries of examples 4 and 5, their battery performance was kept high, compared with that of Example 6, even when the coating composition was subjected to shearing force. And in the battery of Example 6, where the percentage by volume of the conductive additive to the coating for a positive electrode material was 1.4%, its battery performance was a little low, compared with that of Examples 4 and 5, after it was subjected to shearing force.

In the battery of Example 7, where a mixed material of acetylene black and graphite was used as the conductive additive, its battery performance was kept high even when the coating was subjected to shearing force, just like the batteries of Examples 1 and 4, where the percentage by volume of the conductive additive to the coating for a positive electrode material was the same as that of Example 7, specifically 5%.

These confirm that the percentage by volume of the conductive additive to the coating for a positive electrode material affects the battery performance, but the difference in the material for the conductive additive does not affect the battery performance.

Examination was also made of the volume ratio, “(volume of active material+volume of conductive additive)/volume of solvent”, that enables the uniform distribution of the active material and conductive additive in the coating for a positive electrode material.

Coating for positive electrode materials were prepared varying the volume ratio, “(total volume of active material+conductive additive)/volume of solvent”, before dilution and the volume ratio, “(total volume of active material+conductive additive)/volume of solvent”, after dilution. And the coating film resistance was measured for the positive electrode material layers of the positive plates produced using the coating and the battery capacity and high rate performance, after application of shearing force, of the lithium secondary batteries produced using the positive plates were measured.

The measurement was made for the positive plates produced using the coating for positive electrode materials which were prepared so that the conductive additive used accounted for 2.0% of the entire volume of each coating. The results are shown in Table 2.

In the following description, the ratio, “(total volume of active material+conductive additive)/volume of solvent”, will be referred to simply as “volume ratio”.

TABLE 2

| | | Coating film resistance | | Battery capacity | High rate performance | |
|---|---|---|---|---|---|---|
| Volume ratio | | [Ω · cm] | | [mAh] | [Ω · cm] | |
| after | before | right after | after application | after application | after application | |
| dilution | dilution | preparation | of shearing force | of shearing force | of shearing force | Judgement |
| 0.04 | 0.04 | 105 | 159 | 1687 | 0.67 | x |
| | 0.05 | 103 | 143 | 1691 | 0.67 | x |
| | 0.10 | 100 | 110 | 1699 | 0.68 | x |
| | 0.25 | 95 | 105 | 1701 | 0.68 | x |
| | 0.50 | 105 | 144 | 1691 | 0.67 | x |
| | 1.00 | 109 | 133 | 1694 | 0.67 | x |
| | 1.10 | 128 | 162 | 1686 | 0.67 | x |
| | 1.50 | 179 | 199 | 1677 | 0.66 | x |
| | 2.00 | 126 | 278 | 1658 | 0.64 | x |
| 0.05 | 0.05 | 92 | 97 | 1717 | 0.71 | ∘ |
| | 0.10 | 85 | 95 | 1717 | 0.71 | ∘ |
| | 0.25 | 64 | 83 | 1720 | 0.72 | ∘ |
| | 0.50 | 83 | 92 | 1718 | 0.71 | ∘ |
| | 1.00 | 86 | 93 | 1719 | 0.71 | ∘ |
| | 1.10 | 121 | 154 | 1688 | 0.67 | x |
| | 1.50 | 138 | 167 | 1685 | 0.66 | x |
| | 2.00 | 150 | 201 | 1676 | 0.66 | x |
| 0.50 | 0.50 | 75 | 97 | 1717 | 0.70 | ∘ |
| | 1.00 | 76 | 99 | 1712 | 0.70 | ∘ |
| | 1.10 | 159 | 301 | 1652 | 0.64 | x |
| | 1.50 | 170 | 10152 | 1431 | 0.42 | x |
| | 2.00 | 210 | 26476 | 540 | 0.25 | x |
| 1.00 | 1.00 | 95 | 99 | 1712 | 0.70 | ∘ |
| | 1.10 | 434 | 1021 | 1561 | 0.55 | x |
| | 1.50 | 871 | 15709 | 1163 | 0.36 | x |
| | 2.00 | 2051 | 29820 | 489 | 0.24 | x |
| 1.10 | 1.10 | 630 | 2053 | 1547 | 0.53 | x |
| | 1.50 | 1220 | 20295 | 899 | 0.34 | x |
| | 2.00 | 5902 | 30291 | 456 | 0.15 | x |

* Volume ratio = (total volume of active material + conductive additive)/volume of solvent
The percentage of the volume a conductive additive accounts for was standardized to be 2.0%.

The coating for positive electrode materials was prepared in the same manner as in Example 1 or Comparative Example 1. The term “coating before dilution” means, in terms of the preparation process of Comparative Example 1, the coating prepared right after introducing 30 parts by volume of active material, which is a Li-containing mixed oxide, and 2 parts by volume of conductive additive into 22 parts by volume of solvent. The term “coating after dilution” means, in terms of the preparation process of Comparative Example 1, the coating prepared after further introducing 2 parts by volume of binder and 42 parts by volume of solvent into the coating before dilution and kneading the same for 60 minutes.

The coating having the same volume ratio before and after dilution shown in table 2 was prepared in one step of dilution, unlike the coating of Comparative Example 1 which was prepared in two steps of dilution.

In other words, the coating having the same volume ratio before and after dilution shown in table 2 was prepared in the same manner as in Example 1, whereas the coating having the different volume ratios before and after dilution shown in table 2 was prepared in the same manner as in Comparative Example 1.

It is seen from the results shown in Table 2 that in the batteries produced using the positive plates in which the coating film resistance of the positive electrode material layers was kept low even-after application of shearing force, their battery capacity and high rate performance were kept high even after application of shearing force.

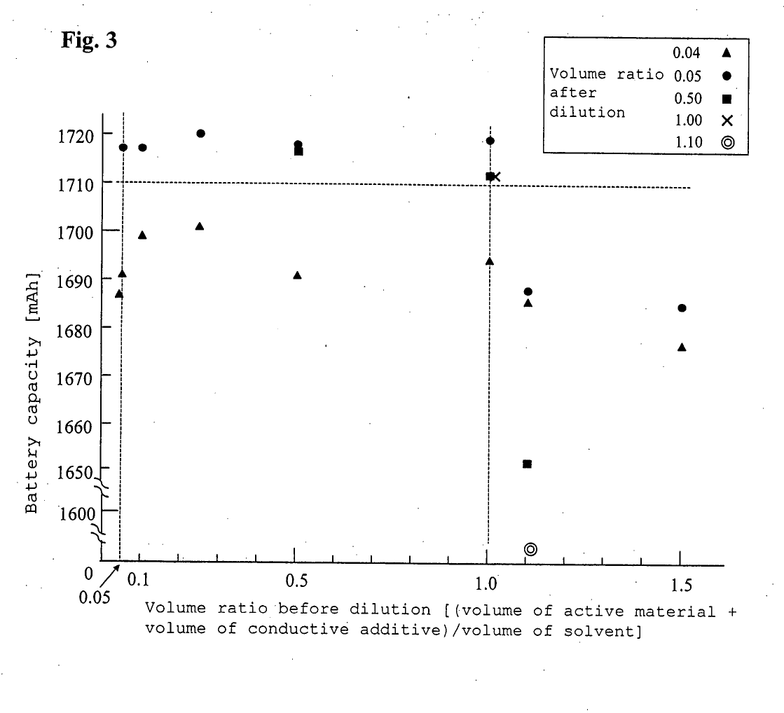

FIG. 3 is a graph showing the relationship between the volume ratio before diluting the coating for positive electrode materials and the battery capacity of the produced batteries, where the present inventors' attention was paid to the results of the battery capacity in Table 2.

Comparison of the coating with the volume ratio before dilution of 1.0 and with that of 1.1 in FIG. 3 reveals that the battery capacity was rapidly lowered when the volume ratio before dilution became 1.1. Thus, to produce a positive plate which enables the production of batteries whose battery capacity can be kept high, it is preferable to use a coating for a positive electrode material with the volume ratio before dilution of 1.0 or less.

Comparison of the coating, focusing attention on the volume ratio after dilution, in FIG. 3 reveals that when the volume ratio after dilution was in the range of 0.05 to 1.00, the battery capacity was stably kept as high as 1710 mAh or more, whereas when the volume ratio after dilution became 0.04, the battery capacity could not be kept high even if the volume ration before dilution was changed. Accordingly, to produce a positive plate which enables the production of batteries whose battery capacity can be kept high, it is preferable to use a coating for a positive electrode material with the volume ratio after dilution of 0.05 or more.

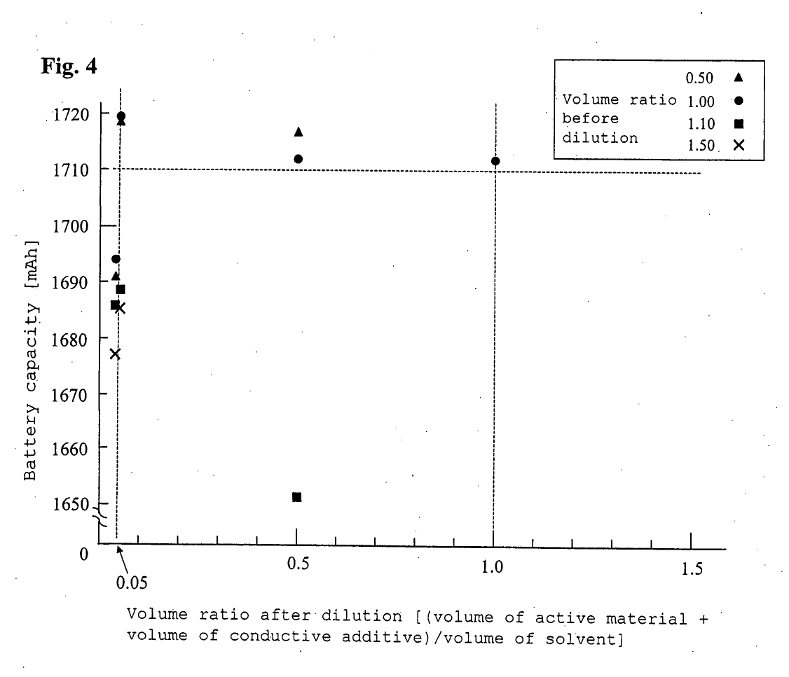

FIG. 4 is a graph showing the relationship between the volume ratio after diluting the coating for positive electrode materials and the battery-capacity of the produced batteries, where the present inventors' attention was paid to the results of the battery capacity in Table 2.

As shown in Table 2, the battery capacity obtained when the volume ratio after diluting the coating for positive electrode materials was 1.1 or more was 1600 mAh or less, which was outside the range shown in FIG. 4 (1650 mAh or more), and therefore not described in FIG. 4.

Comparison of the coating with the volume ratio after dilution of 1.0 and with that of 1.1 in FIG. 4 reveals that the battery capacity was rapidly lowered when the volume ratio after dilution became 1.1 (outside the range shown in FIG. 4). Thus, to produce a positive plate which enables the realization of batteries whose battery capacity can be kept high, it is preferable to use a coating for a positive electrode material with the volume ratio after dilution of 1.0 or less.

Comparison of the coating, focusing attention on the volume ratio after dilution, in FIG. 4 reveals that when the volume ratio after dilution was in the range of 0.05 to 1.00, the battery capacity was stably kept as high as 1710 mAh or more, whereas when the volume ratio after dilution became 0.04, the battery capacity could not be kept high even if the volume ratio before dilution was changed. Accordingly, to produce a positive plate which enables the production of batteries whose battery capacity can be kept high, it is preferable from FIG. 4 as like FIG. 3 to use a coating for a positive electrode material with the volume ratio after dilution of 0.05 or more.

It is seen from Table 2 that when the volume ratio before dilution is 0.05, it is preferable to use a coating for a positive electrode material with the volume ratio before dilution of 0.05 or more, because even if the coating is not diluted (the volume ratio before dilution is 0.05), the battery capacity of the produced battery can be kept high.

The reason the battery capacity is lowered when using a coating with the volume ratio of higher than 1.00 is that in coating with such volume ratios the aggregation of the conductive additive used progresses and the distribution thereof becomes non-uniform.

The reason the battery capacity is lowered when using a coating with the volume ratio of lower than 0.05 is that the powder area is so small that the number of collisions among powder particles is decreased during the coating preparing step, and the conductive additive used is dispersed and cannot form primary particles.

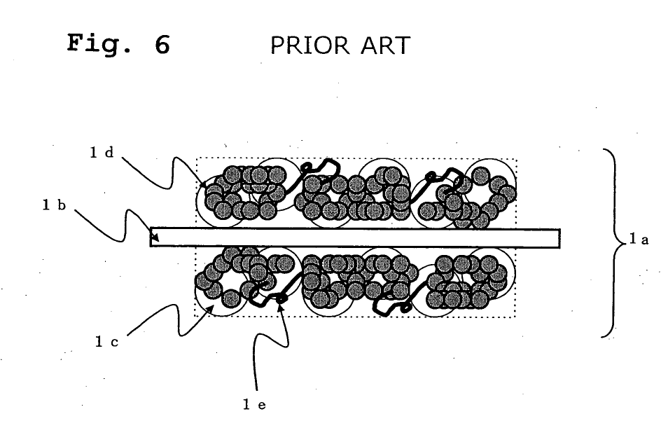

Specifically, when producing a positive electrode using a coating with the volume ratio, (total volume of active material+conductive additive)/volume of solvent, outside the range of 0.05 to 1.00 through the steps right before the drying step, the shearing force applied to the coating in the actual coating step or re-agitation step causes the aggregation of the conductive additive to progress, leading to the non-uniform distribution of the conductive additive in the positive electrode material layers, as shown in FIG. 6. Thus, the variation in the magnitude of the shearing force applied to the coating creates a variation in the electronic conductivity of the produced positive electrode, which results in variations in battery performance such as battery capacity and cycle performance of the batteries as final products.

Depending on the type of the solvent used, its volume percentage in the coating is decreased due to its evaporation or absorption of moisture in the air, and the conductive additive may undergo consolidation in the coating step. Accordingly, it is preferable to keep the volume ratio to the coating in the range of 0.05 to 1.0 during both the coating preparing step and the coating step.

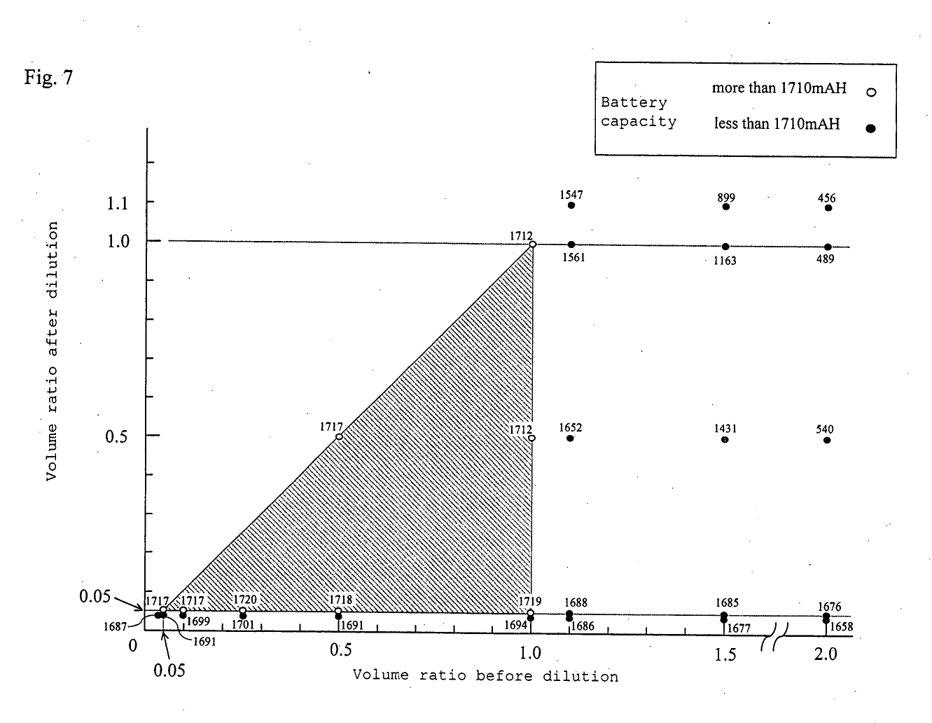

What has been described so far is summarized in FIG. 7. In other words, FIG. 7 is a graph showing the relationship between the volume ratios of “active material+conductive additive” to “solvent” in a coating for a positive electrode material before and after dilution and the battery capacity of the batteries produced in examples of the present invention.

As described above and is evident from FIG. 7, the volume ratio lower than 0.05 after dilution is not preferable, because in such a case, the area of the powder material is so small that the number of collisions among powder particles is decreased during the coating preparing step, and the conductive additive used is dispersed and cannot form primary particles.

As described above and is also evident from FIG. 7, the volume ratio higher than 1.00 after dilution is not preferable, because in such a case, the battery capacity is lowered because the aggregation of the conductive additive used progresses and the distribution thereof becomes non-uniform.

Further, as described in the section “Description of the Related Art” and is also evident from FIG. 7, the volume ratio higher than 1.0 before dilution is not preferable, because in such a case, agitation of the coating produces excessive shearing force so that the aggregation of the conductive additive used further progresses and the distribution of the conductive additive in the positive electrode layers becomes non-uniform.

Further, as the battery capacity is stably kept as high as 1710 mAh or more in the volume ratio on line of the triangle shown by the crosshatched part in FIG. 7, even within the triangle it is presumed that the battery capacity be kept equally. As a result, it is clear that excellent battery capacity characteristics are exhibited in the range shown by the crosshatched triangle in FIG. 7, that is, the range in which the volume ratio defined in the present invention falls.

The volume rate of the conductive additive to the entire coating for a positive electrode material was examined which allowed the distribution of the active material and the conductive additive in the coating composition to be uniform.

Coating for positive electrode materials were prepared varying the volume ratio, “(total volume of active material+conductive additive)/volume of solvent”, before dilution and “the percentage by volume of the conductive additive in the coating for positive electrode materials”. And the coating film resistance was measured for the positive electrode material layers of the positive plates produced using the coating and the battery capacity and high rate performance, after application of shearing force, of the lithium secondary batteries produced using the positive plates were measured.

The measurement was made for the positive plates produced using the coating for positive electrode materials which were prepared so that the volume ratio, “(total volume of active material+conductive additive)/volume of solvent”, was 0.5. The results are shown in Table 3.

TABLE 3

| Percentage | | | | | | |
|---|---|---|---|---|---|---|
| of volume a | Volume | Coating film resistance | | Battery capacity | High rate performance | |
| conductive | ratio | [Ω · cm] | | [mAh] | [Ω · cm] | |
| additive | before | right after | after application | after application | after application | |
| accounts for (%) | dilution | preparation | of shearing force | of shearing force | of shearing force | Judgement |
| 1.4 | 0.50 | 101 | 129 | 1695 | 0.68 | x |
| | 1.00 | 130 | 136 | 1694 | 0.68 | x |
| | 1.10 | 142 | 878 | 1553 | 0.56 | x |
| | 1.50 | 189 | 10583 | 1410 | 0.42 | x |
| | 2.00 | 217 | 26741 | 522 | 0.25 | x |
| 1.5 | 0.50 | 92 | 99 | 1712 | 0.70 | ∘ |
| | 1.00 | 96 | 99 | 1713 | 0.70 | ∘ |
| | 1.10 | 107 | 252 | 1661 | 0.65 | x |
| | 1.50 | 130 | 581 | 1603 | 0.57 | x |
| | 2.00 | 141 | 767 | 1578 | 0.56 | x |
| 2.0 | 0.50 | 81 | 90 | 1715 | 0.70 | ∘ |
| | 1.00 | 86 | 89 | 1716 | 0.70 | ∘ |
| | 1.10 | 101 | 224 | 1670 | 0.66 | x |
| | 1.50 | 129 | 300 | 1645 | 0.60 | x |
| | 2.00 | 140 | 511 | 1603 | 0.60 | x |
| 5.0 | 0.50 | 75 | 89 | 1719 | 0.71 | ∘ |
| | 1.00 | 80 | 87 | 1719 | 0.71 | ∘ |
| | 1.10 | 95 | 160 | 1688 | 0.67 | x |
| | 1.50 | 129 | 201 | 1677 | 0.66 | x |
| | 2.00 | 137 | 352 | 1643 | 0.63 | x |
| | 0.50 | 46 | 60 | 1723 | 0.72 | ∘ |
| | 1.00 | 58 | 80 | 1721 | 0.72 | ∘ |
| 10.0 | 1.10 | 88 | 152 | 1689 | 0.67 | x |
| | 1.50 | 89 | 155 | 1689 | 0.67 | x |
| | 2.00 | 89 | 154 | 1689 | 0.67 | x |
| | 0.50 | 15 | 19 | 1515 | 0.49 | x |
| | 1.00 | 21 | 24 | 1555 | 0.54 | x |
| 11.0 | 1.10 | 22 | 25 | 1564 | 0.55 | x |
| | 1.50 | 25 | 33 | 1605 | 0.64 | x |
| | 2.00 | 26 | 35 | 1608 | 0.63 | x |

*Volume ratio = (total volume of active material + conductive additive)/volume of solvent
The volume ratio after dilution was standardized to be 0.5.

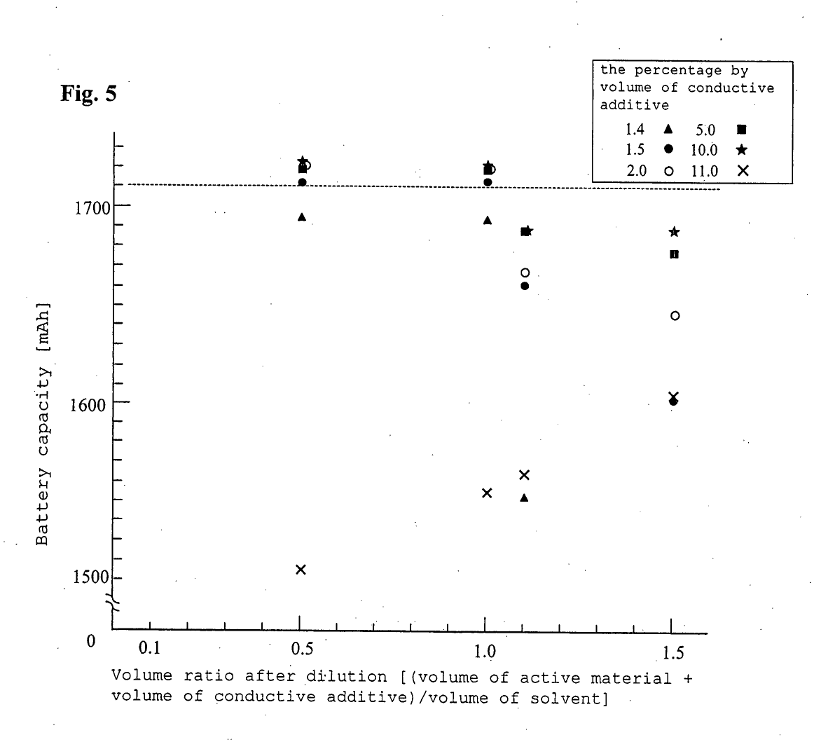

FIG. 5 is a graph showing the relationship between the volume ratio before diluting the coating for positive electrode materials and the battery capacity of the produced batteries, when varying the percentage by volume of the conductive additive to the entire coating, where the present inventors' attention was paid to the results of the battery capacity in Table 3.

Comparison of the coating with the volume ratio before dilution of 1.0 and with that of 1.1 or more in FIG. 5 reveals that the battery capacity was rapidly lowered when the volume ratio before dilution became 1.1 even though the percentage by volume of the conductive additive to the entire coating was varied. This agrees with the results show in FIG. 3. Thus, to produce a positive plate which enables the production of batteries whose battery capacity can be kept high, it is preferable to use a coating for a positive electrode material with the volume ratio before dilution of 1.0 or less.

Here, the percentage by volume of the conductive additive to the entire coating for a positive electrode material will be examined when the volume ratio before dilution is 1.0 or less.

When focusing attention on the relation ship between the percentage by volume of the conductive additive to the entire coating for a positive electrode material and the battery capacity for the coating with the volume ratio before dilution of 0.5 and with that of 1.0 in FIG. 5, the battery capacity was stably kept as high as 1710 mAh or more when the percentage by volume of the conductive additive to the entire coating for a positive electrode material was in the range of 1.5% to 10%. In contrast, when such percentage by volume became less than 1.5% or more than 10%, the battery capacity was rapidly lowered and could not be stably kept as high as 1710 mAh or more.

Accordingly, to produce a positive plate which enables the production of batteries whose battery capacity can be kept high, it is preferable to use a coating for a positive electrode material in which the percentage by volume of the conductive additive to the entire coating is in the range of 1.5% to 10%.

As shown in Table 5, calculating the value, (volume of conductive additive)/(total volume of active material+conductive additive+binder), in cases where the volume ratio of the solvent to the entire coating is in the range of 68% to 55%, makes it clear that the percentage by volume of the conductive additive to the entire coating in the range of 1.5% to 10% corresponds to that in the range expressed by the following equation: 0.03≦(volume of conductive additive)/(total volume of active material+conductive additive+binder)≦0.25. Accordingly, in the lithium batteries produced using coating in which the value, (volume of conductive additive)/(total volume of active material+conductive additive+binder), is 0.03 or more and 0.25 or less, their battery capacity can be kept high.

TABLE 5

| | | | | Conductive |
|---|---|---|---|---|
| | | | | additive/(active |
| Volume ratio | | | | material + |
| active | conductive | | | conductive |
| material | additive | binder | solvent | additive + binder) |
| 28.0 | 2 | 2 | 68 | 0.06 |
| 28.0 | 10 | 2 | 60 | 0.25 |
| 41.5 | 1.5 | 2 | 55 | 0.03 |

Further, it is preferable from the viewpoints described below to use a coating for a positive electrode material in which the percentage by volume of the conductive additive to the entire coating is in the range of 2% or less.

If the amount of the conductive additive is decreased, the amount of the conductive additive whose specific surface area is markedly large is also decreased, whereby the amount of gases generated is decreased. This inhibits the internal pressure of batteries from increasing. If the increase in the internal pressure cannot be inhibited, in other words, if the internal pressure is increased, the safety device or circuit in batteries starts up, the batteries do not operate.

If the percentage by volume of the conductive additive is more than 2%, it becomes necessary to, for example, add an additive to the electrolyte to inhibit the increase in the internal pressure with certainty. However, the increase in the internal pressure can be inhibited if only the percentage by volume of the conductive additive is kept 2% or less.

The value, 2% or less, can also be taken as above. Specifically, as shown in Table 5, calculating the value, (volume of conductive additive)/(total volume of active material+conductive additive+binder), in cases where the volume ratio of the solvent to the entire coating is in the range of 68% to 55%, makes it clear that the percentage by volume of the conductive additive to the coating in the range of 1.5% to 2% corresponds to that in the range expressed by the following equation: 0.03≦(volume of conductive additive)/(total volume of active material+conductive additive+binder)≦0.06.

Accordingly, in the lithium batteries produced using coating in which the value, (volume of conductive additive)/(total volume of active material+conductive additive+binder), is 0.03 or more and 0.06 or less, their battery capacity can be kept high; and besides, increase in their internal pressure can be inhibited more effectively.

If a coating for a positive electrode material is prepared so that the percentage by volume of the conductive additive to the entire coating is less than 1.5%, the plate resistance of the resultant positive plate cannot be made 100 Ω·cm or less. As a result, the rate of electron transfer from the core material to the active material is decreased, which causes the battery capacity and the cycle performance batteries to be lowered. In Table 2 and Table 3, battery performance is described in terms of battery capacity and high rate performance and when high rate performance is excellent, cycle performance seems to be excellent.

If the percentage by volume of the conductive additive to the entire coating for a positive electrode material is more than 10%, it becomes necessary to decrease the amount of the active material that releases lithium ions, which participate in reaction, though the rate of electron transfer is increased. This results in the deterioration of the battery capacity.

Investigation was also made of the relationship between the coating film resistance of the positive electrode material layers after application of shearing force and battery performance. The term “coating film resistance of the positive electrode material layers” herein used means the volume resistance in the present invention. The results are shown in Table 4.

TABLE 4

| | | Percentage | | | | High rate | |
|---|---|---|---|---|---|---|---|
| Coating film resistance | | of volume a | | | Battery capacity | performance | |
| [Ω · cm] | | conductive | Volume ratio | | [mAh] | [Ω · cm] | |
| right after | after application | additive | after | before | after application | after application | |
| preparation | of shearing force | accounts for (%) | dilution | dilution | of shearing force | of shearing force | Judgment |
| 28 | 39 | 11.0 | 0.50 | 2.20 | 1703 | 0.69 | x |
| 30 | 40 | 10.5 | 0.50 | 0.50 | 1712 | 0.71 | ∘ |
| 89 | 100 | 5.0 | 0.48 | 1.05 | 1712 | 0.71 | ∘ |
| 100 | 110 | 2.0 | 0.04 | 0.10 | 1699 | 0.68 | x |
| 434 | 1021 | 2.0 | 1.00 | 1.10 | 1561 | 0.55 | x |
| 86 | 10130 | 2.0 | 0.50 | 1.49 | 1438 | 0.42 | x |
| 217 | 26741 | 1.4 | 0.50 | 2.00 | 522 | 0.25 | x |

*Volume ratio = (total volume of active material + conductive additive)/volume of solvent

When focusing attention on the coating film resistance of the positive electrode material layers after application of shearing force shown in Table 4, it is seen that when using positive plates having a coating film resistance of 40 Ω·cm or more and 100 Ω·cm or less, batteries was realized whose battery capacity was stably kept as high as 1710 mAh or more. In contrast, when producing batteries using positive plates having a coating film resistance of less than 40 Ω·cm or more than 100 Ω·cm, their battery capacity was rapidly lowered and could not be stably kept as high as 1710 mAh or more.

The lower the coating film resistance of the positive electrode material layers becomes, the higher performance the produced battery has. However, to decrease the coating film resistance to less than 40 Ω·cm, the percentage by volume of the conductive additive to the entire coating must be 10% or more. To do so, it becomes necessary to decrease the amount of the active material that releases lithium ions, which participate in reaction. This results in the deterioration of the battery capacity, as shown in Table 4.

If the coating film resistance is higher than 100 Ω·cm, the rate of electron transfer from the core material to the active material is decreased, which causes the battery capacity and the cycle performance of the produced batteries to be lowered.

Conversely, it is seen from Table 3 that use of a coating for a positive electrode material which is prepared so that the volume ratio before dilution, “(total volume of active material+conductive additive)/volume of solvent” is 0.5 or 1.0 and the percentage by volume of the conductive additive to the entire coating is in the range of 1.5% to 10% makes it possible to produce a positive plate having a coating film resistance after application of shearing force of 40 Ω·cm or more and 100 Ω·cm or less.

In examples of the present invention, the criteria by which to judge the results shown in Table 2 to Table 4 to be acceptable or not were: 1710 mAh or more for battery capacity; and 0.70 Ω·cm or more for high rate performance. These criteria are those requested by a certain manufacturer. Batteries that meet these criteria are on a level that causes no problems when using.

As described so far, use of the process of preparing a coating for a positive electrode material for lithium secondary batteries of the present invention makes it possible to produce positive electrode material layers having a stable and high electronic-conductivity eve n when the coating for its positive electrode material has been subjected to large shearing force and realize positive electrodes for lithium secondary batteries having excellent battery capacity and high rate performance in which variations are decreased.

The positive electrodes for lithium secondary batteries produced using the process of preparing a coating for a positive electrode material for lithium secondary batteries of the present invention have excellent battery capacity and high rate performance which are free from variations; therefore, they can be used for applications of energy storage devices such as solid electrolyte lithium secondary batteries and nickel metal hydride batteries.

What is claimed is:

1. A process of preparing a coating for a positive electrode material for lithium secondary batteries, the coating comprising, at least, an active material which is a Li-containing mixed oxide, a conductive additive, a binder and a solvent,
wherein the process comprises mixing the active material, conductive additive, binder and solvent so that the ratio of the volume of the active material and the volume of the conductive additive to the volume of the solvent in said coating is kept during the processing in the range expressed by the following equation:
0.05≦(volume of active material+volume of conductive additive)/volume of solvent≦1.00.

2. The process of preparing a coating for a positive electrode material for lithium secondary batteries according to claim 1, wherein the conductive additive accounts for 1.5% or more and 10% or less of the volume of the entire coating for a positive electrode material.

3. The process of preparing a coating for a positive electrode material for lithium secondary batteries according to claim 1, wherein the conductive additive accounts for 1.5% or more and 2% or less of the volume of the entire coating for a positive electrode material.

4. A positive electrode for lithium secondary batteries produced in: a coating step of applying, onto a current collector, a coating prepared by a process of preparing a coating for a positive electrode material for lithium secondary batteries according to any one of claims 1 to 3; and a drying step of removing the solvent from the coating applied onto the current collector,
wherein the positive electrode comprises a material layer in which the ratio of the volume of the conductive additive to the total volume of the active material, conductive additive and binder is in the range expressed by the following equation:
0.03≦(volume of conductive additive)/(volume of active material+conductive additive+binder)≦0.25, and a current collector.

5. A positive electrode for lithium secondary batteries produced in: a coating step of applying, onto a current collector, a coating prepared by a process of preparing a coating for a positive electrode material for lithium secondary batteries according to any one of claims 1 to 3; and a drying step of removing the solvent from the coating applied onto the current collector,
wherein the positive electrode comprises a material layer in which the ratio of the volume of the conductive additive to the total volume of the active material, conductive additive and binder is in the range expressed by the following equation:
0.03≦(volume of conductive additive)/(volume of active material+conductive additive+binder)≦0.06, and the current collector.
